(19) United States
(12) Patent Application Publication
(10) Pub. No.: US 2018/0130160 A1
(43) Pub. Date: May 10, 2018

(54) Systems, Devices, and/or Methods for Managing Transportation

(71) Applicants: Peter Alexander, Lynchburg, VA (US); Demetrius Alexander, Lynchburg, VA (US); Chase Montney, Forest, VA (US)

(72) Inventors: Peter Alexander, Lynchburg, VA (US); Demetrius Alexander, Lynchburg, VA (US); Chase Montney, Forest, VA (US)

(21) Appl. No.: 15/807,538

(22) Filed: Nov. 8, 2017

Related U.S. Application Data
(60) Provisional application No. 62/419,367, filed on Nov. 8, 2016.

(51) Int. Cl. G06Q 50/30; G08G 1/00; G01S 19/42; G06Q 10/02; G06Q 20/12

(52) U.S. Cl. CPC G06Q 50/30; G08G 1/202; G06Q 30/0252; G06Q 10/02; G06Q 20/12; G01S 19/42

(57) ABSTRACT

Certain exemplary embodiments can provide a method, which comprises causing a customer to be picked up by a first vehicle. The customer is picked up responsive to a received first request to transport the customer to a first business location or event. The first business location or event one of a plurality of predetermined business locations or events to which transportation is offered.

### CROSS-REFERENCES TO RELATED APPLICATIONS

This application claims priority to, and incorporates by reference herein in its entirety, pending U.S. Provisional Patent Application Ser. No. 62/419367 (Attorney Docket No. 1174-01, filed Nov. 8, 2016.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a flowchart of an exemplary embodiment of a method 2000; and

FIG. 3 is a block diagram of an exemplary embodiment of an information device 3000.

### DETAILED DESCRIPTION

Certain exemplary embodiments can provide a method, which comprises causing a customer to be picked up by a first vehicle. The customer is picked up responsive to a received first request to transport the customer to a first business location or event. The first business location or event one of a plurality of predetermined business locations or events to which transportation is offered.

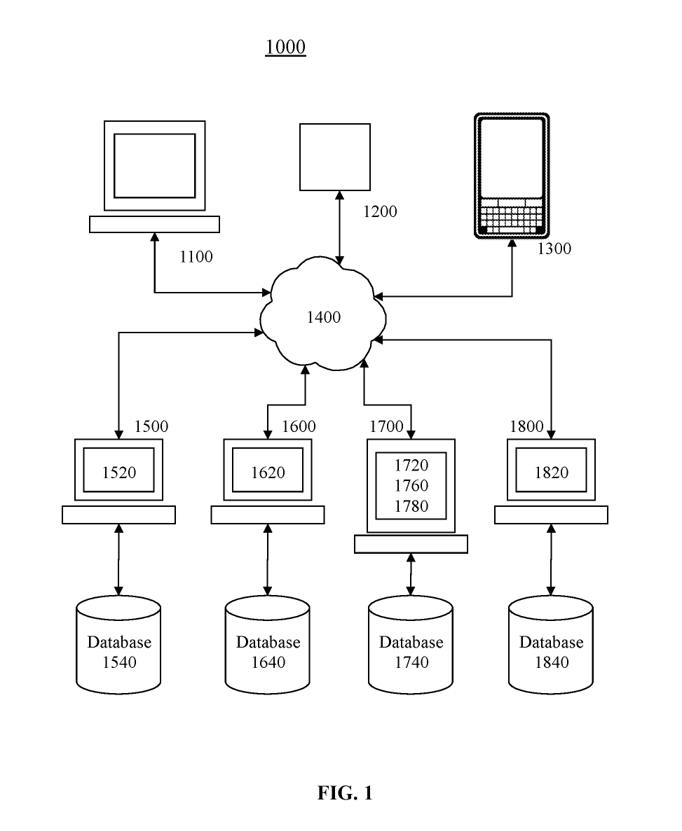

FIG. 1 is a block diagram of an exemplary embodiment of a system 1000, which can comprise a smartphone 1300, an information device 1100, tablet 1200, a network 1400, a first server 1500, a second server 1600, a third server 1700, and a fourth server 1800. First server 1500 can comprise a first user interface 1520 and can be coupled to a first database 1540. Second server 1600 can comprise a second user interface 1620 and can be coupled to a second database 1640. Third server 1700 can comprise a third user interface 1720, a processor 1760, machine instructions 1780, and can be coupled to a third database 1740. Fourth server 1800 can comprise a fourth user interface 1820 and can be coupled to a fourth database 1840. Any of the methods and/or steps thereof can be carried out in whole or in part by tablet 1200, smartphone 1300, information device 1100 and/or first server 1500. Second server 1600, third server 1700, and/or fourth server 1800 can each be associated with implementation of a system via which rides are provided to customers. In certain exemplary embodiments, system 1000 can be used to implement one or more methods disclosed herein.

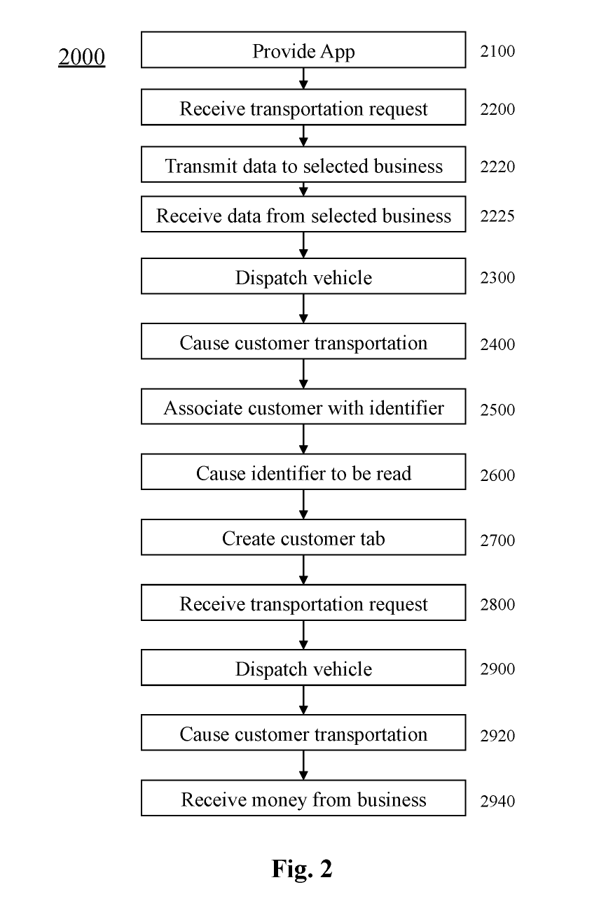

FIG. 2 is a flowchart of an exemplary embodiment of a method 2000. At activity 2100, application software (an “App”) can be provided to a customer (e.g., via a download over the Internet). In other embodiments, the customer can access method 2000 via a website. The App provided allows the customer to initiate actions concerning patronizing a business establishment or event. For example, the business establishment can be a bar, a pub, a restaurant, a nightclub, and/or a business that serves alcoholic beverages. The business can also be a business associated with one or more ticketed sales events such as, for example, sporting events, music events (e.g., concerts), weddings and/or festivals, etc. As an example, a portion of a sporting event ticket that the customer purchases that have been partnered with, at a predetermined amount, will then be paid as consideration for the ride service and, via the App, customers are offered rides to and from the event. The App comprises a pre-determined set of businesses and/or events to which transportation is offered. The customer executes the App (e.g., via an information device such as information device 1100, tablet 1200, or smartphone 1300 of FIG. 1). The App provides a user interface to the customer that requests identifying information from the customer. In certain exemplary embodiments, the request is from an entity associated with the first business location or event. The customer can be queried by the App for the personal information via the user interface. The identifying information can comprise name, address, telephone number, birthdate, and/or credit card number, etc. In certain exemplary embodiments, once the identifying information is entered, the customer can create a username and password such that the identifying information does not need to be entered more than once. In such embodiments, the customer can login after the identifying information is entered once and information devices such as first server 1500, upon validation of the login, can automatically retrieve the identifying information. The App can provide the customer with a list of business establishments and/or events to which transportation is offered. The customer can select a business or event from the list of businesses and/or events and the App transmits the request a request for transportation. In an alternative embodiment, the App can receive a request for transportation from another App or website of a partnering business or event. The request for transportation can be for an individual or can be for a group of people associated with the individual. If the request is for a group of people, the App prompts the customer, via the user interface, to provide any and all additional addresses at which people will be picked up to travel to the selected business or event. Certain exemplary embodiments comprise receiving information from the customer comprising one or more addresses of people to be transported to the first business location or event. In certain exemplary embodiments, the App can render advertising information to the customer. Certain exemplary embodiments can cause rendering an advertisement to the customer based upon the first business location or event.

At activity 2200, the transportation request is received from the customer. The request can be from the customer and can be transmitted from an application on a second user interface of a personal computing device. The customer can select the first business location or event from a predetermined list of business locations or events via a second user interface. Once the request is received, a decision can be made as to which of a plurality of vehicles should be dispatched to pick up the customer and any other persons for whom transportation has been requested. In certain exemplary embodiments, the decision as to which vehicle to dispatch can be made automatically via an information device based upon Global Positioning System (“GPS”) information of each of the plurality of vehicles and the proximity of each of those vehicles to the customer and/or any other persons for whom transportation has been requested. In other embodiments, a dispatcher can direct pick up of the customer without knowledge of the relative GPS coordinates of either the vehicle dispatched and/or the customer. For example, a customer can book a ride and the information is then sent to a dispatcher who receives the information and calls, texts, or emails the driver with instructions to pick up the customer. The customer can book a ride from any location. All drivers will be required to pass a background check prior to being dispatched to provide any rides.

At activity 2220, data concerning the customer and/or any other persons for whom transportation has been requested to the selected business or event can be transmitted to the selected business or event. For example, data can be transmitted to a dedicated tablet (e.g., an iPad®) informing the selected business or event of a number of patrons to be transported to the selected business or event and an estimated arrival time. The selected business or event can then confirm or deny a reservation for the customer and/or any other persons for whom transportation has been requested. If the selected business or event cannot accommodate the customer and/or any other persons for whom transportation has been requested, the business or event can deny a reservation and the App can automatically notify the customer of such denial. Upon such denial, the customer can potentially select another business or event establishment via the App.

At activity 2225, data concerning the customer and/or any other persons for whom transportation has been requested to the selected business or event can be received from the selected business or event. For example, and acceptance or a denial of the reservation for the customer from the first business location or event can be received.

At activity 2300, the vehicle is dispatched to pick up the customer. In certain exemplary embodiments, the transportation to the selected business or event can be free of charge to those being transported in the sense that there is no fare explicitly charged. In certain exemplary embodiments, the customer and/or any other persons for whom transportation has been requested can provide one or more tips to the driver for services rendered. The amount of any such tips can be left entirely to the discretion of the customer and/or any other persons for whom transportation has been requested. In other embodiments, the cost of the ride can be paid by the entity dispatching the vehicle. In other embodiments, the customer requesting a ride can pay for the ride or buy tickets through the App and/or via other means. For example, purveyors of events, sporting venues, concerts, and/or weddings, etc. can provide funding for the ride. Certain exemplary embodiments can cause transmitting information to the customer comprising at least one of a license plate number, a photograph of the first vehicle, or a photograph of a driver of the first vehicle.

At activity 2400, certain exemplary embodiments can cause the vehicle can pick up the customer and/or any other persons for whom transportation has been requested and provide transportation to the selected business or event. In certain exemplary embodiments, the App can provide information concerning the vehicle and/or the driver of the vehicle to the customer. For example, a license plate number, photograph of the vehicle, and/or a photograph of the driver of the vehicle can be automatically provided to the customer. In addition, the App can provide an estimated time of arrival of the vehicle. In certain exemplary embodiments, the App can cause the driver of the vehicle to automatically receive information concerning the customer. For example, photograph of the customer, and/or a photograph of a location (e.g., a photograph from Google Earth®) can be automatically provided to the driver of the vehicle. In certain exemplary embodiments, more than one customer and/or set of customers can be picked up and share a given ride. For example, two customers can book a ride at different addresses and can be picked up according to a fastest and/or most efficient route. Customers can agree, explicitly or implicitly, to an arrangement wherein both customers can be picked up with or without a given customer's prior knowledge or with or without the customers knowing each other prior to being picked up. The customer may also “group” rides together by adding other locations to pick up friends along the way that will have to same common destination.

Certain exemplary embodiments cause a customer to be picked up by a first vehicle. The customer can be picked up responsive to a received first request to transport the customer to a first business location or event. The first business location or event can be one of a plurality of predetermined business locations or events to which transportation is offered.

Personal information regarding the customer is received responsive to a received first request. The first vehicle can be selected from a plurality of vehicles to provide transportation of the customer to the first business location or event. The first vehicle can be selected from the plurality of vehicles based upon a proximity of the first vehicle relative to a location of the customer.

A signal can be transmitted to a first entity associated with the first business location or event. The signal can be indicative that the customer is being transported to the first business location or event and an approximate arrival time of the customer. A confirmation or denial of a reservation can be received for the customer from the first business location or event.

Certain exemplary embodiments can cause an identifier to be provided to the customer. The identifier constructed for the first business location or event to track at least one of billing or location of the customer. The identifier can be caused to be read at the first business location or event, wherein the identifier is used to confirm that the customer has arrived. Via the identifier, the location of the customer is caused to be transmitted to the first business location or event. A second request is received to transport the customer from the first business location or event, the second request made via a first user interface available to the customer. Responsive to the second request, a second vehicle is dispatched to pick up the customer. The second request can cause transportation of the customer to a second business location or event

At activity 2500, the customer can be associated with an identifier. The identifier can be any identifier known to those skilled in the art. For example, the identifier can be a card with a magnetic strip and/or machine-readable chip, a bracelet, and/or any object comprising a Radio-frequency identification (“RFID”) tag. The identifier can be used by the business until the customer is picked up for a return trip. In certain exemplary embodiments, the identifier referenced can be provided purely by GPS and no other identifier may be needed. The business can have GPS coordinates built into its system, and by using the App, the GPS of the customer's phone can be determined to be at particular coordinates that identify the customer prior to pick up and can automatically tell the destination business (e.g., bar, restaurant, business or venue) when the customer is delivered to the destination business. The identifier can be based on GPS coordinates and not any kind of tangible product. In certain exemplary embodiments, neither the destination business nor the customer will have any type of physical identifier. The customer can be identified for pickup location via GPS or a manual address entered. Once the address is entered for pick up location by the customer and it is routed this might be unalterable. If the customer is not at the pick up location when the driver arrives the customer will be charged a flat fee (e.g., $5.00).

At activity 2600, the customer arrives at the selected business or event and the identifier can be read by the selected business or event. In certain exemplary embodiments, the identifier can be read automatically and/or wirelessly, such as by an RFID reader. In other embodiments, the identifier can be read via a magnetic card reader and/or a card chip reader. Via reading the identifier, the selected business or event can verify that the customer has arrived, such as via the dedicated tablet.

At activity 2700, the selected business or event can then create a tab for the customer, which can be automatically updated on the dedicated tablet and transmitted from the dedicated tablet to a server for processing. In other embodiments, the tab can be tracked by the selected business or event and a hard copy of the full bill associated with the customer and/or any other persons for whom transportation has been requested can be required by a driver of a dispatched vehicle for a trip from the selected business or event to another location. Certain exemplary embodiments can cause a tab to be started at the first business location or event responsive to the identifier being read at the first business location or event. Certain exemplary embodiments can cause a hard copy of a tab to be printed at the first business location or event responsive to the identifier being read at the first business location or event. The customer can be responsible for taking a photo of their receipt to match the tab they have just paid. If this is not done the customer can be charged a flat fee (e.g., $20). The customer will have a predetermined time period (e.g., a 24 hour time period) to satisfy the receipt. This can be automatically prompted when the customer requests a ride home or to another business. In certain exemplary embodiments, there might not be a requirement for a hard copy of the tab. Such done digitally and can be the responsibility of the customer.

At activity 2800, the App can receive a request for transportation from the customer at the location of the business, venue, and/or event. The request at activity 2800 is for pickup of the customer and/or any other persons for whom transportation has been requested from the selected business or event to travel to another location. The App can provide the customer with a user interface that allows the customer to return home and/or be transported to a selected one of a plurality of other businesses and/or events. If the customer chooses to be transported to another selected business or event, method 2000 can repeat beginning at activity 2300.

At activity 2900, a vehicle can be dispatched to pick up the customer. In some circumstances, the vehicle of activity 2900 will be the same vehicle dispatched at activity 2300. In other circumstances, the vehicle of activity 2900 will be a different vehicle than that dispatched at activity 2300. The vehicle can be automatically selected based upon a GPS location of the vehicle as compared to the GPS location of the selected business or event. Thus, the closest available vehicle can be used for transportation of the customer. In certain exemplary embodiments, drivers can be dispatched to pick up the customer such as via email, text, and/or telephone.

At activity 2920, the App can cause customer transportation. Thus, the dispatched vehicle can pick up the customer for transportation to the customer's home or any other non-business location. As a condition for the ride provided pursuant to activity 2920, the customer can be required to provide the driver of the dispatched vehicle with a copy of a complete tab for the selected business or event. Certain exemplary embodiments can cause the customer to be required to provide a copy of a complete tab for the customer of the first business location or event. The driver of the dispatched vehicle can then either scan or take a digital photograph of the complete tab and provide the scan or digital photograph to a server. In other embodiments, the driver can retain a hard copy of the complete tab for further processing. In an alternate embodiment, the customer can provide a photo of their tab or receipt via the app, which can automatically allow the customer to request a ride home or to another business, bar, event, or venue. In certain exemplary embodiments, the ride can be provided without a metered charge for the transportation. In such embodiments, the driver of the vehicle can be paid in tips. In other embodiments, the driver can charge a fee for the transportation that is negotiated with the customer.

At activity 2940, money from the business or event can be received. The money received from the business or event can be a percentage of the tab for any and/or all moneys spent by the customer and/or any other persons for whom transportation has been requested. For example, the selected business or event might have agreed to pay approximately 20% of moneys received for a tab in order to be listed as a business or event on the App. In certain exemplary embodiments, payments can be made by the selected business or event on a periodic basis (e.g., monthly). In other exemplary embodiments, a business, event, bar, restaurant, or venue, may also be charged a flat monthly or annual fee for customer transportation services not based on a commission and potentially in addition to a commission, for a set negotiated period time. After that time has expired, a renegotiation of the monthly or annual amount can be established for another set period or time. This can be for one or many locations of that certain business, event, bar, restaurant, or venue.

Also for events, there can be a flat fee deemed for each ticket sold that uses transportation services at a predetermined and negotiated amount. Events can be a one-time event, occur annually, or on a regular basis such as a seasonal period of time. For example, the App can reflect a partnership with a chain restaurant and an agreement can exist to service five locations. The restaurant can pay a full or partial up front fee or X amount of dollars, to begin providing transportation services. This can be a monthly fee or a annual fee. This may be compensation entirely or can be a fee plus commission. As another example, the customer can purchase a “ride free” ticket to a baseball game. A portion of the purchase price is given to the “ride free” business that provides transportation to that customer to and from the event. Certain exemplary embodiments can cause money, as a percentage of a complete tab of the customer at the first business location or event, to be transferred from the first business location or event to a second entity associated with the first vehicle. Certain exemplary embodiments can cause money, as a flat fee from the first business location or event, to be transferred to a second entity associated with the first vehicle. Certain exemplary embodiments can cause transportation is provided to the customer without a metered charge. In certain exemplary embodiments, a portion of a ticket price paid by the customer is provided as compensation for transportation, wherein the ticket price was paid prior to the request from the customer for transportation. In certain exemplary embodiments, the customer does not pay for transportation at when transported.

Certain exemplary embodiments can cause a customer to be picked up by a first vehicle. The customer can be picked up responsive to a received first request to transport the customer to a first business location or event. The first business location or event can be one of a plurality of predetermined business locations or events to which transportation is offered. A signal is transmitted to an entity associated with the first business location or event. The signal can be indicative that the customer is being transported to the first business location or event and an approximate arrival time of the customer. Certain exemplary embodiments can cause the customer to be provided with an identifier. The identifier can be constructed for the business event or location to track at least one of billing or location of the customer. Certain exemplary embodiments can cause the identifier to be read at the first business location or event. The identifier can be used to confirm that the customer has arrived. Via the identifier, certain exemplary embodiments can cause a location of the customer to be transmitted to the first business location or event.

There can be a flat fee (e.g., a $20 fee) associated to each ride that the customer does not satisfy the requirements of taking a photo of the receipt from the restaurant/venue to which a ride is provided. Such charges can be made after a predetermined time period (e.g., after 24 hours). There can be a flat fee (e.g., a $20 fee) associated to each customer that is not at the pick up location at the time of the drivers arrival, resulting in a missed ride.

In certain exemplary embodiments, there is no physical identifier that the customer or the patterning business will have. There can be a “auto check” where when predetermined longitude and latitude GPS coordinates of the restaurant/venue are entered by the traveling customer based on his/her GPS on their smartphone. The customers can add multiple stops to pick up friends along the way to a common destination. The customers may go from one partnering business to another before returning to their final destination.

Certain exemplary embodiments provide a mobile application (“App”). Customers can use this App to book a free round trip ride to a pre-determined list of restaurants that the App provider partners with. However, these businesses that the App provider partners with might not have any relationship/communication with its customers that will impact their free ride. For example, the business partner does not need to know/will not interact with any App provider customer in a way that will be required for transportation services. This means that the business partner will not be responsible for checking any customers in or be required to assist in any step of the process.

Certain exemplary embodiments can provide a caveat for transparency with business partners; the business partners can log in to their own version of the App and/or a website and view analytics, metrics, and overall summary data/dashboards of how many customers we are bringing to their place of business that will also include how many customers are in route, etc. Certain exemplary embodiments can also include monthly automated reports sent to business partners with the specifics, attached proof of sales and transportation requests from of customers to promote transparency as business partners can be auto-billed for each customer transported on a periodic (e.g., daily) basis.

Certain exemplary embodiments can utilize a process, which can comprise:
When a customer uses the App, they can sign up/register with the required information, agree to terms and conditions, and place a credit card on file. The customer can then book a ride just as they would using the App however, the destination list can be refined to predetermined locations (depending on their location at the time which is reviewed by the application). Once they request a ride, our independent contractors utilizing their personal vehicles receive the request on their version of the App via their smartphone. The application automatically allocates the rides to the drivers that are nearest and are available. Once the drivers accept, the customer will see that the driver is on their way and will be able to see an estimate of time, etc.
Once the customer is picked up. The driver brings the customer to a business partner. This ride can be completely free to the passenger other than the option to either tip through the App by the supplied credit card on file or provide a cash tip to the driver.
The customer then can proceed to the business/restaurant/bar. Once the customer is done at this business they can use the App they are able to request a ride home (or anywhere they request within our distance logic) or they can request to go to another restaurant. When this request is entered into our mobile app, the app knows that they received a ride previously and will ask for them to enter/scan their receipt and information in order to initiate the next ride. There will be an option below that allows the customer to “do this later” and alerts the customer that if they choose this option will have 24 hours to submit this information to ensure a free ride; otherwise their credit card on file will be charged a onetime flat fee for the ride (we're currently determining this fee).
If the customer requests to go to another restaurant, one or more steps of the process can be repeated. If the customer requests to go home and submits information or selected “do this later”. The driver can pick them up and take them home. The customer can have an option to tip the driver via the App or with cash.
If the customer elects an “I'll do this later” option and does not submit the information within a predetermined time period (e.g., 24 hours), the App can automatically audit any customers that have booked that have not supplied the information within 24 hours and charge their credit card. If the information is provided; the App can automatically utilize the information on file from the booking/additional information provided to calculate how much money was spent at the place of business and charge the business for transportation services.
After money is collected from either the customer (e.g., if proof of sale wasn't provided as agreed) or from the business partner; the mobile App can automatically determine which driver completed the customer's booking (e.g. Driver A took customer to restaurant and Driver B took customer home). A percentage of money received for the service provided can be credited to each driver according to one or more independent contractor agreements.

Certain exemplary embodiments can utilize a process, which can comprise:
Driver A takes customer to a business partner and Driver B takes customer home. Customer spends $100.00 at the business partner, the business partnership agreement states that it will pay 20% of the Customer's tab for transportation. The App owner collects $20.00 from the business partner. The App owner then pays Drivers A & B an agreed upon percentage of money collected from business partner. (e.g. The App owner collects $20.00 and agrees to pay 50% of profit split across associated drivers; Driver A will receive $5.00 and Driver B will receive $5.00. Driver A & B also retain 100% of any tips provided by customer).

Certain exemplary embodiments can utilize a process, which can comprise:
Driver A takes customer to a business partner and Driver B takes customer home. Customer spends $100.00 at the business partner, the business partnership agreement states that it will pay 20% of the Customer's tab for transportation, however customer does not provide information within 24 hours. The App owner collects a flat fee of $20.00 from customer's credit card according to terms of service. The App owner then pays Drivers A & B agreed upon percentage of money collected from customer (e.g. the App owner collects $20.00 and agrees to pay 50% of profit split across associated drivers; Driver A will receive $5.00 and Driver B will receive $5.00. Driver A & B also retain 100% of any tips provided by customer).

Certain exemplary embodiments can utilize a process, which can comprise:
Driver A takes customer to business partner A. Customer spends $100.00 at business partner A, the business partnership agreement states that it will pay 20% to the App owner of a customer's tab. Customer requests to be taken to business partner B and submits required information for Business Partner A. Driver B takes customer to business partner B. Customer spends $100.00 at business partner B and the business partnership agreement states that it will pay 20% of a customer's tab to the App owner. Customer requests to go home and submits required information for Business Partner B. Driver C takes customer home. The App owner collects the agreed upon percentage from business partners A & B (e.g., $40.00 total) and=the App owner pays drivers A, B, & C agreed upon percentage of money collected from business partner A & B. (e.g. the App owner collects $40.00 total and agrees to pay 50% of profit split across associated drivers. Driver A will receive $13.33, Driver B will receive $13.33, and Driver C will receive $13.33. Each driver will also retain 100% of any tips provided by customer.).

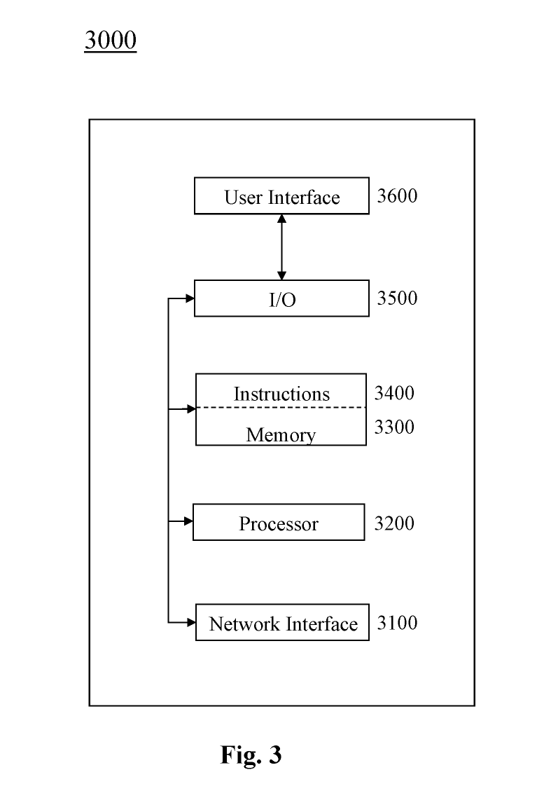

FIG. 3 is a block diagram of an exemplary embodiment of an information device 3000, which in certain operative embodiments can comprise, for example, information device 1100, of FIG. 1. Information device 3000 can comprise any of numerous circuits and/or components, such as for example, one or more network interfaces 3100, one or more processors 3200, one or more memories 3300 containing instructions 3400, one or more input/output devices 3500, and/or one or more user interfaces 3600 coupled to one or more input/output devices 3500, etc.

In certain exemplary embodiments, via one or more user interfaces 3600, such as a graphical user interface, a customer can view a rendering of information related to transportation to a business establishment.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapted to—made suitable or fit for a specific use or situation.
address—information that identifies a place where a person is located at.
advertisement—rendered information calling something to the attention of a user of an information device.
and/or—either in conjunction with or in alternative to.
apparatus—an appliance or device for a particular purpose.
application—machine instructions that perform a particular task or set of tasks.
approximate arrival time—an estimate of when a person will be at a particular location.
arrive—to reach a place.
associate—to join, connect together, and/or relate.
automatically—acting or operating in a manner essentially independent of external influence or control. For example, an automatic light switch can turn on upon “seeing” a person in its view, without the person manually operating the light switch.
available—rendered on a device viewable by.
based upon—used as a criterion for a determination.
billing—an accounting of money owed by a customer.
business location—a site at which goods or services are provided to customers.
can—is capable of, in at least some embodiments.
cause—to bring about.
circuit—an electrically conductive pathway and/or a communications connection established across two or more switching devices comprised by a network and between corresponding end systems connected to, but not comprised by the network.
compensation—payment for a thing of value tendered or a service rendered.
complete—substantially whole or entire.
comprising—including but not limited to.
configure—to make suitable or fit for a specific use or situation.
confirm—to acknowledge with definite assurance.
convert—to transform, adapt, and/or change.
copy—written or rendered text.
couple—to link in some fashion.
customer—a user of a good or service.
data—distinct pieces of information, usually formatted in a special or predetermined way and/or organized to express concepts.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
define—to establish the outline, form, or structure of
deny—to refuse to acknowledge or provide assurance.
determine—to obtain, calculate, decide, deduce, and/or ascertain.
device—a machine, manufacture, and/or collection thereof.
dispatch—to send to a destination.
driver—an operator of a vehicle.
entity—a person or business.
estimate—to calculate and/or determine approximately and/or tentatively.
event—something that occurs in a certain location during a particular interval of time.
flat fee—a fixed charge amount for something.
generate—to create, produce, give rise to, and/or bring into existence.
Global Position System (GPS)—a system adaptable to determine a terrestrial location of a device receiving signals from multiple satellites.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
hard copy—a copy of textual or graphic information (as from computer storage) produced on paper.
identifier—data that is uniquely associated with a person. For example, an identifier can comprise a name, an address identified via a GPS signal, a social security number, a driver's license number, a credit card number, a debit card number, a card with a magnetic strip and/or machine-readable chip, a bracelet, and/or any object comprising a Radio-frequency identification (“RFID”) tag, etc.
indicative—signifying.
information—data that has been organized to express concepts.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
install—to connect or set in position and prepare for use.
license plate—a government issued placard comprising a unique vehicle identifier.
location—a place substantially approximating where something physically exists.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
metered charge—a billed amount proportional to a distance traveled.
method—a process, procedure, and/or collection of related activities for accomplishing something.
money—any item or verifiable record that is generally accepted as payment for goods and services and repayment of debts in a particular country or socio-economic context.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
offer—to present a service for acceptance or rejection.
paid—money conveyed to an entity.
pay—to convey money.
percentage—a defined proportion of something.
personal computing device—an information device small enough to hold and operate in a user's hand.
personal information—data that is unique to a particular individual. For example, name, address, phone number, e-mail address, credit card number, and/or a photographic image, etc.
photograph—an image created by on a photographic film or electronically; wherein electronically created images are storable on a memory device.
pick up—to offer to transport or transport via a vehicle.
plurality—the state of being plural and/or more than one.
portion—a part of a whole.
predetermined—established in advance.
print—to make a copy of by impressing paper against an inked printing surface.
prior to—earlier in time.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, California. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—to calculate, estimate, or predict.
provide—to furnish, supply, give, and/or make available.
proximity—nearness in space or one thing to another.
query—to request information.
read—received and interpreted as a signal comprising information.
receive—to get as a signal, take, acquire, and/or obtain.
recommend—to suggest, praise, commend, and/or endorse.
relative to—in comparison with.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
reservation—an arrangement made beforehand.
responsive—reacting to an influence and/or impetus.
repeatedly—again and again; repetitively.
request—to express a desire for and/or ask for.
require—to demand something.
select—to choose from a plurality of alternatives.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
store—to place, hold, and/or retain data, typically in a memory.
substantially—to a great extent or degree.
system—a collection of mechanisms, devices, machines, articles of manufacture, processes, data, and/or instructions, the collection designed to perform one or more specific functions.
tab—a bill or creditor's record of promises to pay.
ticket price—an amount paid for access to a location or an event.
track—to observe or monitor the course or path of something, as by wireless signals.
transfer—to convey from one entity to another.
transmit—to send as a signal, provide, furnish, and/or supply.
transport—to carry, move, or convey from one place to another.
transportation—conveying at least one person from a first location to a second location.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
vehicle—a device or structure for transporting persons or things. A vehicle can be a car, truck, locomotive, and/or mine haul truck, etc.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
causing a customer to be picked up by a first vehicle, the customer picked up responsive to a received first request to transport the customer to a first business location or event, the first business location or event one of a plurality of predetermined business locations or events to which transportation is offered, wherein:
personal information regarding the customer is received responsive to received first request;
the first vehicle is selected from a plurality of vehicles to provide transportation of the customer to the first business location or event;
the first vehicle is selected from the plurality of vehicles based upon a proximity of the first vehicle relative to a location of the customer, wherein:
a signal is transmitted to a first entity associated with the first business location or event, the signal indicative that the customer is being transported to the first business location or event and an approximate arrival time of the customer;
confirmation or denial of a reservation is received for the customer from the first business location or event;
the customer is caused to be provided with an identifier, the identifier constructed for the first business location or event to track at least one of billing or location of the customer;
the identifier is caused to be received by the first business location or event, wherein the identifier is based upon GPS coordinates;
via the identifier, the location of the customer is caused to be transmitted to the first business location or event;
a second request is received to transport the customer from the first business location or event, the second request made via a first user interface available to the customer; and
responsive to the second request, a second vehicle is dispatched to pick up the customer.

2. The method of claim 1, further comprising:
dispatching the first vehicle to pick up the customer.

3. The method of claim 1, further comprising:
receiving a denial of the reservation for the customer from the first business location or event.

4. The method of claim 1, further comprising:
causing a tab to be started at the first business location or event responsive to the identifier being read at the first business location or event.

5. The method of claim 1, further comprising:
causing a hard copy of a tab to be printed at the first business location or event responsive to the identifier being read at the first business location or event.

6. The method of claim 1, further comprising:
rendering an advertisement to the customer based upon the first business location or event.

7. The method of claim 1, further comprising:
receiving information from the customer comprising one or more addresses of people to be transported to the first business location or event.

8. The method of claim 1, further comprising:
transmitting information to the customer comprising at least one of a license plate number, a photograph of the first vehicle, or a photograph of a driver of the first vehicle.

9. The method of claim 1, further comprising:
causing the customer to be required to provide a copy of a complete tab for the customer of the first business location or event.

10. The method of claim 1, further comprising:
causing money, as a percentage of a complete tab of the customer at the first business location or event, to be transferred from the first business location or event to a second entity associated with the first vehicle.

11. The method of claim 1, further comprising:
causing money, as a flat fee from the first business location or event, to be transferred to a second entity associated with the first vehicle.

12. The method of claim 1, wherein:
transportation is provided to the customer without a metered charge.

13. The method of claim 1, wherein:
the second request causes transportation of the customer to a second business location or event.

14. The method of claim 1, wherein:
a portion of a ticket price paid by the customer is provided as compensation for transportation, wherein the ticket price was paid prior to the request from the customer for transportation.

15. The method of claim 1, wherein:
the customer does not pay for transportation when transported.

16. The method of claim 1, wherein:
the customer is queried by the application for the personal information via the user interface.

17. The method of claim 1, wherein:
the request is from the customer and is transmitted from an application on a second user interface of a personal computing device.

18. The method of claim 1, wherein:
the customer selects the first business location or event from a predetermined list of business locations or events via a second user interface.

19. The method of claim 1, wherein:
the request is from an entity associated with the first business location or event.

20. A method comprising:
causing a customer to be picked up by a first vehicle, the customer picked up responsive to a received first request to transport the customer to a first business location or event, the first business location or event one of a plurality of predetermined business locations or events to which transportation is offered, wherein:
a signal is transmitted to an entity associated with the first business location or event, the signal indicative that the customer is being transported to the first business location or event and an approximate arrival time of the customer;
the customer is caused to be provided with an identifier, the identifier constructed for the business event or location to track at least one of billing or location of the customer;
the identifier is caused to be read at the first business location or event, wherein the identifier is used to confirm that the customer has arrived; and
via the identifier, a location of the customer is caused to be transmitted to the first business location or event.
